(19) United States
(12) Patent Application Publication
(10) Pub. No.: US 2016/0180336 A1
(43) Pub. Date: Jun. 23, 2016

(54) INFORMATION PROCESSING APPARATUS, INFORMATION PROCESSING METHOD, AND INFORMATION PROCESSING PROGRAM

(71) Applicant: Rakuten, Inc., Tokyo (JP)

(72) Inventors: Yutaka Jinno, Tokyo (JP); Hiromitsu Ishii, Tokyo (JP)

(73) Assignee: Rakuten, Inc., Tokyo (JP)

(21) Appl. No.: 14/442,121

(22) PCT Filed: May 31, 2013
(86) PCT No.: PCT/JP2013/065284

§ 371 Date: May 12, 2015

(51) Int. Cl. G06Q 20/38; G06Q 40/02

(52) U.S. Cl. CPC G06Q 20/38; G06Q 40/025

(57) ABSTRACT

Additional information designated by a user is provisionally registered as information relating to a specific event until sales billing information relating to the specific event becomes presentable to the user. Then, after the sales billing information is acquired, an information management server 2 registers the sales billing information and the additional information that is provisionally registered in association with the sales billing information, to be presentable to the user, in association with each other.

### TECHNICAL FIELD

The present invention relates to a technical field of a system and the like that performs registration of first information designated by a user as information relating to a specific event and second information relating to the specific event in association with each other.

### BACKGROUND ART

Conventionally, a system is known in which, when a member of a credit card makes a transaction at a card affiliated store for shopping or the like by using the credit card, details of the transaction (for example, sales billing information) according to the card are browsable from a terminal of the member through a network.

Meanwhile, there is a request for enabling a corresponding comment to be browsable from a terminal on a system in association with a transaction according to a credit card while the member's memory is clear. Relating to the request, in Patent Literature 1, a system has been disclosed in which card use information at the time of performing member authorization and determining (so called authorization) the availability/non-availability of the card and a comment received from a member terminal integrated with being associated with each other based on a matching key.

### PRIOR ART LITERATURE

### Patent Literature

Patent Literature 1: JP 2005-063216 A

### SUMMARY OF THE INVENTION

### Problem to be Solved by the Invention

Meanwhile, in the system in which details of a transaction using a card can be browsed from the terminal by the member of the credit card, timing at which the details of the transaction become browsable depends on the operation of a card affiliated store. Depending on the operation, there are cases where the details of a transaction become browsable when a long time elapses after the transaction, and, in such cases, the member may not think out a specific content of the transaction even when viewing the details. Thus, there is inconvenience that the member needs to leave a comment in a house keeping book or a diary and associate the comment with the details of the transaction.

In the system disclosed in Patent Literature 1, a target to be associated with the comment is not details of a transaction but card use information acquired at the time of member authorization. Even in a case where a comment is associated with the card use information, the comment cannot be associated with the details of the transaction based thereon. The reason for this is that the card use information and the details of a transaction are not operated to be associated with one-to-one correspondence.

An object of the present invention is to provide an information processing apparatus, an information processing method, and an information processing program capable of associating (linking) first information such as a comment with second information including details of a transaction or the like easily.

### Means for Solving the Problem

In order to solve the above problem, the invention according to claim 1 is an information processing apparatus comprising:

a provisional registration means that provisionally registers first information designated by a user as information relating to a specific event until second information relating to the specific event becomes presentable to the user; and

a registration means that, after the second information is acquired, registers the second information and the first information that is provisionally registered in association with the second information, to be presentable to the user, in association with each other.

According to this present invention, the first information designated by the user as the information relating to the specific event and the second information relating to the specific event can be easily associated with each other.

The invention according to claim 2 is the information processing apparatus according to claim 1,

wherein the registration means performs association using information associated with the first information as a matching key, and determines whether or not there is insufficient information as the matching key.

According to this invention, the first information can be more easily associated with appropriate second information.

The invention according to claim 3 is the information processing apparatus according to claim 2, further comprising a requesting means that requests sufficient information as information contributing to the association, from the user, only in a case where it is determined that there is insufficient information,

wherein the registration means performs the association based on information acquired in response to the request.

According to this invention, the first information can be more easily associated with appropriate second information.

The invention according to claim 4 is the information processing apparatus according to claim 2 or 3,

wherein the registration means determines whether or not there is insufficient information as the matching key before registration of the second information based on an acquisition state of information acquired before the second information.

According to this invention, in an earlier step before the registration of the second information, it can be determined whether or not there is insufficient information.

The invention according to claim 5 is the information processing apparatus according to claim 3 or 4, wherein the requesting means requests information that is selectable with a predetermined threshold being interposed therebetween as the information contributing to the association, from the user.

According to this invention, the association can be easily performed without requesting a matching key from the user.

The invention according to claim 6 is the information processing apparatus according to any one of claims 1 to 5, wherein the provisional registration means provisionally registers the first information after an occurrence of the event.

According to this invention, the first information can be easily associated with appropriate second information.

The invention according to claim 7 is the information processing apparatus according to any one of claims 1 to 6, wherein the second information is generated before the provisional registration of the first information.

According to this invention, the first information can be easily associated with appropriate second information.

The invention according to claim 8 is the information processing apparatus according to any one of claims 1 to 7,

wherein the registration means registers the second information of which timing at which the second information becomes presentable is incapable of being controlled by the user.

According to this invention, the first information can be easily associated with appropriate second information.

The invention according to claim 9 is the information processing apparatus according to any one of claims 3 to 8,

wherein the first information is additional information designated by the user for a transaction between the user and a store,

the second information is sales billing information of a transaction that is provided from the store,

the registration means determines whether or not there is insufficient information as the matching key, before registration of the second information, based on an acquisition state of credit inquiry information that is acquired before the second information and represents a credit inquiry of the user, and

the requesting means requests information contributing to the association, from the user.

According to this invention, the additional information designated by the user can be more easily associated with appropriate sales billing information based on the acquisition state of the credit inquiry information representing the credit inquiry of the user.

The invention according to claim 10 is the information processing apparatus according to any one of claims 1 to 9, further comprising:

a first presenting means that presents the first information and the second information registered in association with each other by the registration means to the user; and

a correction means that receives a correction instruction for association between the first information and the second information from the user, and corrects the association between the first information and the second information registered by the registration means based on the correction instruction.

According to this invention, the user can make a correction such that the association between the first information and the second information is appropriate.

The invention according to claim 11 is the information processing apparatus according to any one of claims 1 to 10, further comprising a second presenting means that presents the first information and the second information in association with each other to the user before acquisition of the second information, in a case where the first information is determined to be associated with the second information based on related information associated with the first information before the acquisition of the second information.

According to this invention, also in a case where there is a plurality of candidates with which the additional information is to be associated, the user can easily determine one of the candidates with which the additional information is to be associated.

The invention according to claim 12 is an information processing method executed by a computer, the information processing method comprising: a provisional registration step of provisionally registering first information designated by a user as information relating to a specific event until second information relating to the specific event becomes presentable to the user; and

a registration step of, after the second information is acquired, registering the second information and the first information that is provisionally registered in association with the second information, to be presentable to the user, in association with each other.

The invention according to claim 13 is an information processing program that causes a computer to serve as:

a provisional registration means that provisionally registers first information designated by a user as information relating to a specific event until second information relating to the specific event becomes presentable to the user; and

a registration means that, after the second information is acquired, registers the second information and the first information that is provisionally registered in association with the second information, to be presentable to the user, in association with each other.

### Advantageous Effects of the Invention

According to the present invention, first information designated by a user as information relating to a specific event and second information relating to the specific event can be easily associated with each other.

### BRIEF DESCRIPTION OF THE DRAWINGS

FIG. 1 is a diagram that illustrates a schematic configuration example of an information processing system S according to this embodiment.

FIG. 2A is a diagram that illustrates a schematic configuration example of an information management server 2; and FIG. 2B is a diagram that illustrates an example of functional blocks of a system control unit 24.

FIG. 3A is a diagram that illustrates an example of an additional information provisional registration list; and FIGS. 3B and 3C are conceptual diagrams that illustrate examples of acquisition timing of credit inquiry information, additional information, and sales billing information.

FIG. 4 is a diagram that illustrates an example of display of sales billing information and additional information.

FIG. 5 is a sequence diagram that illustrates an example of operations performed in the information processing system S.

FIG. 6A is a flowchart that illustrates an example of a provisional registration process performed by a system control unit 24 of an information management server 2; and FIG. 6B is a flowchart that illustrates an example of a registration process performed by the system control unit 24 of the information management server 2.

### EMBODIMENTS FOR CARRYING OUT THE INVENTION

Hereinafter, embodiments of the present invention will be described with reference to the drawings. The embodiments described below are embodiments of a case where the present invention is applied to an information processing system.

### [1. Schematic Configuration of Information Processing System S]

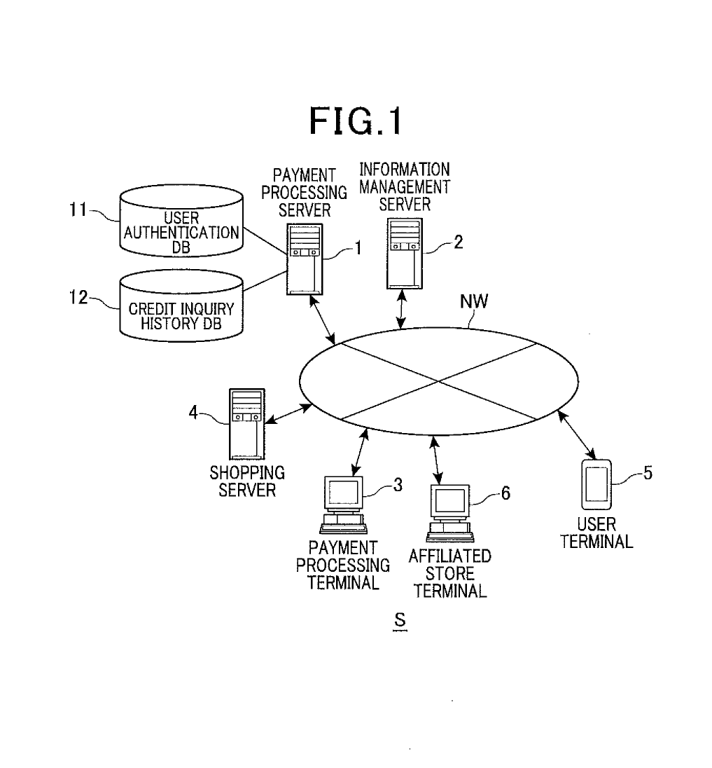

First, a schematic configuration example of an information processing system S according to this embodiment will be described with reference to FIG. 1 and the like. FIG. 1 is a diagram that illustrates a schematic configuration example of the information processing system S according to this embodiment. As illustrated in FIG. 1, the information processing system S according to this embodiment is configured to include a payment processing server 1, an information management server 2, and the like. The payment processing server 1 is a server that performs a payment process for a transaction between an affiliated store (store) having a contract with a credit card company that issues a credit card and a user (member) having a contract with the credit card company. The information management server 2 is a server that provides information relating to a transaction and provides the information for the user. The information management server 2 is an example of an information processing apparatus according to the present invention. The payment processing server 1 and the information management server 2 are connected to a network NW. The network NW is configured by dedicated lines, the Internet, and the like. The payment processing server 1 and the information management server 2, for example, are operated by a credit card company, a management company thereof, or the like. In the example illustrated in FIG. 1, while the payment processing server 1 and the information management server 2 are separated from each other, the payment processing server 1 and the information management server 2 may be integrally configured.

A payment processing terminal 3 of the affiliated store is configured to be connectable to the payment processing server 1 through the network NW. The payment processing terminal 3, for example, is a point of sales (POS) terminal having a credit card settlement function or a credit authorization terminal (CAT) and is installed to an affiliated store. An input device used for inputting a card number, expiration date, and the like of a credit card is connected to the payment processing terminal 3. Alternatively, a reading device that reads a card number, expiration date, and the like of a credit card from an IC chip (or a magnetic stripe) built in the credit card or an IC chip built in a mobile terminal is connected to the payment processing terminal 3. The payment processing terminal 3 transmits a credit inquiry (authorization) request including an affiliated store ID, an affiliated store name, transaction date and time, a transaction amount, and the like in addition to the card number, the expiration date, and the like described above acquired from the input device or the reading device to the payment processing server 1 through the network NW. The affiliated store ID is identification information that is uniquely assigned to each affiliated store and is issued when the affiliated store is registered. In addition, a shopping server 4 is configured to be connectable to the payment processing server 1 through the network NW. The shopping server 4 configures a shopping site (web site) that provides an online shopping mall operated by the affiliated store. In a case where a product is purchased through the shopping site, the shopping server 4, for example, transmits a credit inquiry request including an affiliated store ID, an affiliated store name, transaction date and time, a transaction amount, and the like in addition to the card number, the expiration date, and the like described above input from the user terminal 5 of the user to the payment processing server 1 through the network NW. The user terminal 5, for example, is a personal computer, a mobile phone, or a mobile terminal (for example, a smartphone or a tablet) and has a browser function.

In addition, the payment processing server 1 includes a user authentication database (DB) 11 and a credit inquiry database (DB) 12. In the user authentication database 11, information such as a card number of a credit card, a user name (for example, a name) of a user using a credit card, expiration date, a transaction limit amount, and the like is registered. Then, when the credit inquiry request including an affiliated store ID, an affiliated store name, transaction date and time, a transaction amount, and the like together with the card number, the expiration date, and the like from the payment processing terminal 3 or the shopping server 4, the payment processing server 1 performs a process of a credit inquiry of a user and the like by referring to the user authentication database 11 and replies to the payment processing terminal 3 or the shopping server 4 with availability information that represents the availability/non-availability of the credit card. For example, in a case where the transaction amount is zero Yen or one Yen, the transaction amount is not included in the credit inquiry request. In addition, in one transaction, the credit inquiry request may be performed once or more times. Then, credit inquiry information representing a credit inquiry result for the credit inquiry request described above is registered in the credit inquiry history database 12. In the credit inquiry information, for example, information of an affiliated store ID of an affiliated store that performs the credit request, an affiliated store name, a card number of a credit card, transaction date and time, a transaction amount, availability information, and the like is included. In addition, in the credit inquiry information, generally, an authorization code representing an approval for a credit that is issued at the time of inquiring the credit is included. In a case where the availability information replied to the payment processing terminal 3 or the shopping server 4 represents that the credit card can be used, a transaction between the user and the affiliated store is made, and a settlement (payment) using the credit card is completed.

When the payment is completed in this way, the credit card company receives additional information designated in the transaction with the affiliated store from the user using the credit card. The additional information, for example, is transmitted from the user terminal 5 to an electronic mail address designated by the credit card company. Alternatively, the additional information, for example, is transmitted from the user terminal 5 to a uniform resource locator (URL) designated by the credit card company through a web page. For example, text data (for example, a comment or a memo) relating to the transaction or a file such as still image data, for example, of a photograph of a receipt, a moving image, or a text file corresponds to the additional information. The additional information is an example of “first information designated by the user as information relating to a specific event”. Thereafter, the affiliated store transmits (provides) sales billing information to the credit card company as details of the transaction between the affiliated store and the user using the credit card. The sales billing information is generated on the affiliated store side and, for example, is transmitted from the payment processing terminal 3 to the payment processing server 1 or the information management server 2 through the network NW. Alternatively, the sales billing information is transmitted from an affiliated store terminal 6 of the affiliated store to an electronic mail address designated by the credit card company. The affiliated store terminal 6, for example, is a personal computer, a mobile phone, or a mobile terminal (for example, a smartphone or a tablet) and has a browser function. In addition, in the sales billing information, for example, information such as an affiliated store ID of the store that has sent the sales billing information, an affiliated store name, a user name of a user who has made a transaction at the affiliated store by using the credit card, transaction date and time, and a transaction amount is included. Here, the above-described approval code is included not in the sales billing information but in the credit inquiry information. Meanwhile, the transaction amount is included not in the credit inquiry information but in the sales billing information. In addition, while the credit inquiry request may be made a plurality of times in one transaction, there is one piece of the sales billing information for one transaction. For this reason, it is not always possible to accurately associate a credit inquiry request (in other words, the credit inquiry information) and the sales billing information with each other. Accordingly, as described above, the card use information (the credit inquiry information) and the details of the transaction (the sales billing information) are not operated to be associated with each other to have a one-to-one correspondence.

The credit card company deposits an amount of money that is based on the sales billing information transmitted from the affiliated store into a bank account of the affiliated store. The sales billing information is an example of “second information relating to a specific event” according to the present invention. In addition, the credit inquiry information described above is information that is acquired before the sales billing information. The user authentication database 11 and the credit inquiry history database 12 may be configured to be included not in the payment processing server 1 but in a server other than the payment processing server 1.

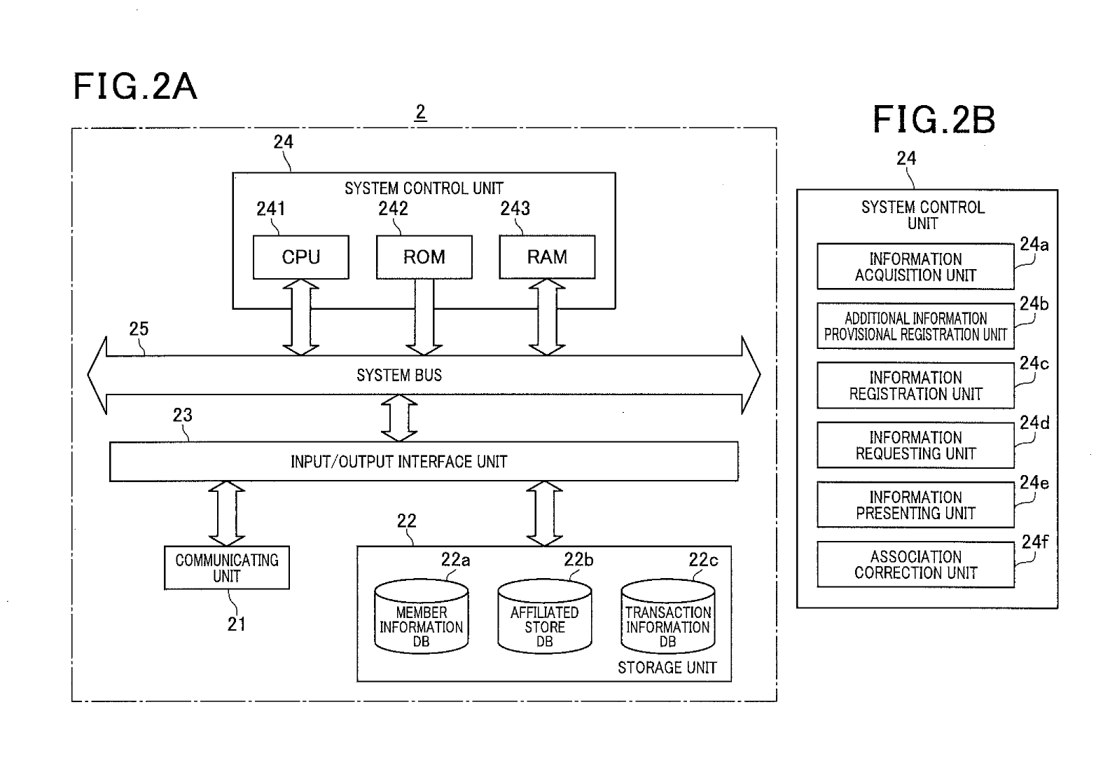

Next, the user terminal 5 of the user using the credit card and the affiliated store terminal 6 are configured to be connectable to the information management server 2 through the network NW. FIG. 2A is a diagram that illustrates a schematic configuration example of the information management server 2. The information management server 2, as illustrated in FIG. 2A, includes a communication unit 21, a storage unit 22, an input/output interface unit 23, a system control unit 24, and the like. The communication unit 21 and the storage unit 22 are connected to the input/output interface unit 23. In addition, the system control unit 24 and the input/output interface unit 23 are interconnected through a system bus 25. The communication unit 21 is connected to the network NW and controls a normal state.

The storage unit 22, for example, is configured by a hard disk drive or the like and stores various programs such as an operating system and a server processing program (including an information processing program according to the present invention). Here, the server processing program, for example, may be configured to be downloaded from a predetermined server or the like through the network NW or may configured to be recorded on a recording medium such as a compact disk (CD) or a digital versatile disc (DVD) and be read from the recording medium.

In addition, in the storage unit 22, a member information database (DB) 22a, an affiliated store information database (DB) 22b, and a transaction information database (DB) 22c are arranged. The member information database 22a is a database that is used for registering member information of a user (member) having a contract with the credit card company for each user. In the member information, for example, a user ID, a password, a user name, an address, a phone number, an electronic mail address, a card number of a credit card, and the like are included. The user ID is identification information that is uniquely assigned to each user and is issued when the user is registered as a member. The affiliated store information database 22b is a database that is used for registering affiliated store information of an affiliated store having a contract with the credit card company for each affiliated store. In the affiliated store information, for example, an affiliated store ID, a password, an affiliated store name, an address, a phone number, an electronic mail address, and the like are included.

The transaction information database 22c is a database that is used for registering the additional information, the sales billing information, and the like together with the information for identifying the user in association with (in other words, in linkage with) the information for identifying the user. The additional information and the sales billing information registered in the transaction information database 22c are managed on the system (the information management server 2) as information that can be presented to the user. Here, timing at which the sales billing information can be presented to the user cannot be controlled by the user. In other words, in the transaction information database 22c, the sales billing information of which the timing, at which the information can be presented to the user, cannot be controlled by the user is registered. In addition, in the transaction information database 22c, a user ID of a user who posts the additional information is registered in association with the additional information. Furthermore, the member information database 22a and the transaction information database 22c may be configured not to be arranged in the storage unit 22 but to be arranged in a server other than the information management server 2.

In addition, in the storage unit 22, an additional information provisional registration list is stored. The additional information provisional registration list is a list used for temporarily registering the additional information, which is acquired by the information management server 2, to be associated with sales billing information that is not registered yet at the time of acquisition of the additional information. Here, “is not registered” means that the additional information is reflected on the system (the information management server 2) as information that can be presented to the user, and particularly in this embodiment, it represents that the additional information is not registered in the transaction information database 22c. Here, registration for the additional information provisional registration list will be referred to as “provisional registration”. In contrast to this, registration for the transaction information database 22c will be referred to as “main registration”. In addition, the sales billing information that is mainly registered, for example, is generated before the provisional registration of the additional information to be associated therewith.

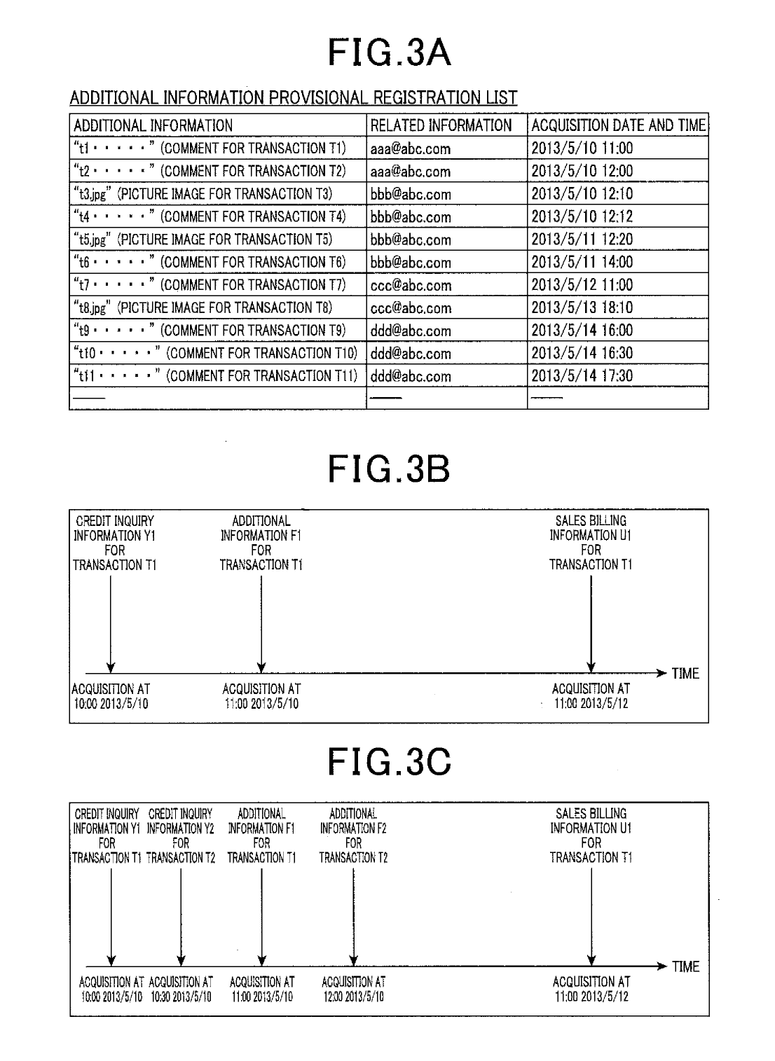

FIG. 3A is a diagram that illustrates an example of the additional information provisional registration list. In the example represented in FIG. 3A, in the additional information provisional registration list, related information associated with the additional information, the acquisition date and time of the additional information, and the like are registered in association with the additional information. This related information is used as a matching key used for matching up the additional information with the sales billing information. For example, in a case where the additional information is transmitted using an electronic email, an electronic mail address of a transmission source, date and time information represented by the electronic mail, and a user name associated with the electronic mail address of the transmission source correspond to the related information. The user name associated with the electronic mail address can be acquired from the member information database 22a. In addition, for example, in a case where image data is attached to the electronic mail, position information (for example, position information acquired by the GPS function of a mobile terminal) added to the image data may be set as the related information. Furthermore, for example, in a case where the additional information is transmitted from a logged-in user to the URL through a web page, a user name, a card number of a credit card, or the like that can be acquired from the member information database 22a using authentication information (for example, a user ID) at the time of user's login as the key may be set as the related information.

The system control unit 24 is configured by a central processing unit (CPU) 241, a read only memory (ROM) 242, a random access memory (RAM) 243, and the like. FIG. 2B is a diagram that illustrates an example of functional blocks of the system control unit 24. The system control unit 24 as a computer executes a process to be described later according to a server processing program stored in the storage unit 22. In such a process, the system control unit 24, as illustrated in FIG. 2B, serves as an information acquisition unit 24a, an additional information provisional registration unit 24b, an information registration unit 24c, an information requesting unit 24d, an information presenting unit 24e, an association correction unit 24f, and the like. Here, the additional information provisional registration unit 24b is an example of a provisional registration means according to the present invention. The information registration unit 24c is an example of a registration means according to the present invention. The information requesting unit 24d is an example of a requesting means according to the present invention. The information presenting unit 24e is an example of a first presenting means and a second presenting means according to the present invention. The association correction unit 24f is an example of a correcting means according to the present invention.

The information acquisition unit 24a acquires the additional information (the additional information designated by the user) posted from the user as described above. The additional information acquired by the information acquisition unit 24a, for example, is stored in a storage area of the RAM 243 that is set in advance for storage of the additional information. In addition, the information acquisition unit 24a acquires the sales billing information transmitted from the affiliated store as described above. The sales billing information acquired by the information acquisition unit 24a, for example, is stored in a storage area of the RAM 243 that is set in advance for storage of the sales billing information. In addition, there are cases where the information acquisition unit 24a acquires the credit inquiry information from the credit inquiry history database 12 through the payment processing server 1.

The additional information provisional registration unit 24b registers (in other words, provisionally registers) the additional information (the additional information designated by the user) acquired by the information acquisition unit 24a in the additional information provisional registration list until the sales billing information can be presented to the user. Here, in a case where the sales billing information with which the additional information is to be associated is already registered at the time of acquisition of the additional information, the additional information may be configured to be registered in the transaction information database 22c in association with the sales billing information without being provisionally registered. A determination on whether or not the sales billing information with which the additional information is associated is already registered, for example, is performed by matching up the additional information with the sales billing information registered in the transaction information database 22c by using the related information associated with the additional information as a matching key. In addition, in a case where the additional information is configured to be necessarily acquired before the registration of the sales billing information, the additional information may be provisionally registered without performing the determination on whether or not the sales billing information with which the acquired additional information is associated is already registered.

After the sales billing information is acquired by the information acquisition unit 24a, the information registration unit 24c registers (in other words, mainly registers) the sales billing information and the additional information in the transaction information database 22c such that the sales billing information and the additional information provisionally registered in association with the sales billing information can be presented to user in association with each other. For example, the information registration unit 24c specifies the additional information that is provisionally registered by the additional information provisional registration unit 24b and the sales billing information acquired by the information acquisition unit 24a by performing matching (association) before the registration of the sales billing information and registers the additional information and the sales billing information in the transaction information database 22c such that the additional information and the sales billing information, which are specified, can be presented to the user in association with each other. In other words, the sales billing information that is a matching target is sales billing information that is not registered (that is not reflected on the system as described above) and may be sales billing information acquired before the additional information to be associated or sales billing information acquired after the additional information to be associated.

In addition, the information registration unit 24c performs matching (association) between the additional information and the sales billing information, for example, by using the related information associated with the additional information as a matching key. For example, in the matching process of a case where a user name is used as the matching key, a search for additional information associated with the user name included in the acquired sales billing information is performed from the additional information that is provisionally registered. Accordingly, one pair of the sales billing information and the additional information to be associated with each other is specified. Here, the sales billing information and the additional information to be associated with each other may be allowed to be in a one-to-N (here, N is two or more) relation. In addition, for example, in a case where a user performs a plurality of transactions in different time zones (for example, a day time and a night time) at different places by using a credit card, and additional information for each transaction is provisionally registered, at least one of date and time information and position information is used as the matching key in addition to the user name. In the matching process of this case, for example, a search for additional information associated with a user name included in the acquired sales billing information and additional information associated with date and time information after transaction date and time included in the acquired sales billing information is performed from the additional information that is provisionally registered. Alternatively, in the matching process of this case, a search for additional information associated with a user name included in the acquired sales billing information and additional information associated with position information that is within a predetermined range from the address of an affiliated store to which an affiliated store ID included in the acquired sales billing information is assigned is performed from the additional information that is provisionally registered. However, by only using the related information associated with the additional information as the matching key, there are cases where sales billing information and additional information associated with each other cannot be specified. As an example of this case, there is a case where a user performs a plurality of transactions at the same affiliated store in the same time zone by using a credit card or the like.

In addition, the information registration unit 24c determines whether or not there is insufficient information as a matching key, for example, before the registration of the sales billing information (for example, certain timing between the acquisition of the additional information to the registration of the sales billing information), and the information requesting unit 24d requests the user for sufficient information as information contributing to the association only in a case where it is determined that there is insufficient information. Here, the “insufficient information” is a key item that is determinant for the association. In addition, while the “sufficient information as information contributing to the association” is information having a high possibility of being additionally acquired from the user, in order to avoid inconvenience for the user, the information is preferably configured as being minimal. The information requesting unit 24d, for example, requests information contributing to the association by transmitting an electronic mail to the electronic mail address of the user who posts the additional information. Alternatively, the information requesting unit 24d, for example, requests the information contributing to the association on a web page displayed on a display of the user terminal 5 after the login of the user who posts the additional information. A card number of a credit card of the user who posts the additional information, transaction date and time, a transaction amount, and the like correspond to the information contributing to the association. Then, the information registration unit 24c performs matching between the additional information and the sales billing information by using the information acquired in response to the request from the information requesting unit 24d as the matching key. Accordingly, the additional information can be easily associated with appropriate sales billing information.

In addition, the information registration unit 24c may be configured to determine whether or not there is insufficient information as the matching key before the registration of the sales billing information based on information that may be acquired before the sales billing information. For example, the credit inquiry information corresponds to the “information that may be acquired before the sales billing information”. In this case, the information acquisition unit 24a acquires credit inquiry information representing the credit inquiry of a user designating the additional information that is provisionally registered from the credit inquiry history database 12 through the payment processing server 1. The credit inquiry information representing the credit inquiry of the user can be specified by using the card number (the card number registered in the member information database 22a) of the credit card of the user as the key. Then, the information registration unit 24c determines whether or not there is insufficient information as the matching key according to the acquisition state of the acquired credit inquiry information before the registration of the sales billing information. Accordingly, the additional information can be easily associated with appropriate sales billing information according to the acquisition state of the credit inquiry information.

FIGS. 3B and 3C are conceptual diagrams that illustrate examples of acquisition timing of the credit inquiry information, the additional information, and the sales billing information. In FIGS. 3B and 3C, for the convenience of description, while the description is represented as “additional information for a transaction T1” and “additional information for a transaction T2”, the description represents the user's subjectivity, and, in a step before the matching between the additional information and the sales billing information, it does not represent that the system (information management server 2) side can determine a transaction to which such additional information corresponds. FIG. 3B illustrates an example in which a total of one transaction T1 is made between the user and the affiliated store. In the case of FIG. 3B, for example, when sales billing information U1 of the transaction T1 is acquired, a situation is formed in which only credit inquiry information Y1 of the transaction T1 is acquired. In such a situation, in order to specify sales billing information with which the additional information F1 for the transaction T1 is associated, it is sufficient to use related information associated with the additional information as the matching key. For this reason, in this case, the information registration unit 24c determines that there is no insufficient information as the matching key.

FIG. 3C illustrates an example in which a total of two transactions T1 and T2 are made between a user and an affiliated store. In the case of FIG. 3C, when the sales billing information U1 of the transaction T1 is acquired, a situation is formed in which credit inquiry information Y1 of the transaction T1 and credit inquiry information Y2 of the transaction T2 are acquired. In such a situation, by only using the related information associated with the additional information as the matching key, it cannot be accurately determined whether the additional information to be associated with the sales billing information U1 of the transaction T1 is the additional information F1 or the additional information F2. For this reason, in this case, the information registration unit 24c determines that there is insufficient information as the matching key, and the information requesting unit 24d requests the user for sufficient information as the information contributing to the association. For example, a card number of a credit card of the user who posts the additional information F1, transaction date and time, a transaction amount, and the like correspond to the information contributing to the association. Here, the information contributing to the association changes according to the acquisition state of the credit inquiry information. For example, in a case (1) where transaction date and time of each of a plurality of pieces of credit inquiry information (for example, Y1 and Y2) is close, the information contributing to the association may be specified as a store name (affiliated store name) or a transaction amount. In a case (2) where the affiliated store IDs of a plurality of pieces of credit inquiry information are the same, the information contributing to the association may be specified as transaction date and time or a transaction amount. In a case where transaction amounts (approval request amounts) of a plurality of pieces of credit inquiry information are close or at least several transaction amounts thereof are not clear, the information contributing to the association may be specified as a store name or transaction date and time. In addition, a case may be considered in which the cases (1) to (3) described above are combined. In this way, for example, by using the transaction date and time and the transaction amount acquired as the information contributing to the association as the matching key, the information registration unit 24c can specify additional information to be associated with the sales billing information U1.

In addition, there may be a width in each of the date and time, the amount of money, and the like. For example, the information requesting unit 24d may be configured to request information that can be selected with a predetermined threshold being interposed therebetween as the information contributing to the association only in a case where it is determined that there is insufficient information. For example, when a smaller amount of transaction amounts (approval request amounts) of two transactions is α1, and a larger amount is α2, there are cases where it is sufficient to ask the user whether the transaction amount is larger/smaller than a predetermined threshold β1 (here, α2≧β1≧═1). More specifically, for example, in a case where the transaction amounts included in a plurality of pieces of credit inquiry information, are 100 Yen and 900 Yen, information (in other words, information that can be selected with the threshold β1 being interposed therebetween) of whether the transaction amount is higher/lower than 500 Yen that is the threshold β1 may be requested from the user as the information contributing to the association. In addition, for example, when former date and time of transaction date and time of two transactions is α3, and the latter date and time is α4, there are cases where it is sufficient to ask the user whether the transaction date and time is before/after predetermined date and time β2 (her, α4≧β2≧α3). More specifically, in a case where transaction date and time included in a plurality of pieces of credit inquiry information is January and May, the information (information that can be selected with the threshold β2 being interposed therebetween) representing whether the transaction date and time is before/after March that is the threshold β2 may be requested from the user as the information contributing to the association.

Here, for example, the determination of whether there is insufficient information as the matching key may be configured to be performed when the additional information F1 is acquired. The reason for this is that the user's memory fades as time elapses from the transaction time, and it is more reasonable to additionally request insufficient information at the time of provisional registration than to additionally request the insufficient information at the time of main registration. In the example represented in FIG. 3C, since a situation is formed in which the credit inquiry information Y1 of the transaction T1 and the credit inquiry information Y2 of the transaction T2 are acquired when the additional information F1 is acquired, at this time point, it can be predicted that the sales billing information of the transaction T1 and the sales billing information of the transaction T2 are acquired thereafter. However, in such a situation, it cannot be determined whether the additional information F1 is to be associated with the sales billing information of the transaction T1 or the sales billing information of the transaction T2 based on only the related information associated with the additional information F1. Accordingly, in this case, the information registration unit 24c, for example, determines that there is insufficient information as the matching key at the time of acquisition of the additional information F1, and the information requesting unit 24d requests information contributing to the association from the user.

The information presenting unit 24e presents the additional information and the sales billing information that are registered in association with each other by the information registration unit 24c to the user. For example, on a web page displayed on the display of the user terminal 5 after the login of the user, the information presenting unit 24e displays the additional information and the sales billing information in association with each other. In other words, the information presenting unit 24e transmits the web page displaying the additional information and the sales billing information in association with each other, for example, from a details browsing web site provided by the credit card company to the user terminal 5, thereby displaying the web page on a web browser. In this way, the additional information and the sales billing information associated with each other is presented to the user. In addition, the information presenting unit 24e may be configured to transmit an electronic mail to which the additional information and the sales billing information are attached to an electronic mail address of the user. Here, the user who posts the additional information and the user to which the additional information is presented may not be necessarily the same. For example, there are cases where a user posts the additional information instead of a user B, and, in such cases, the user B can browse the additional information, for example, through the details browsing web site.

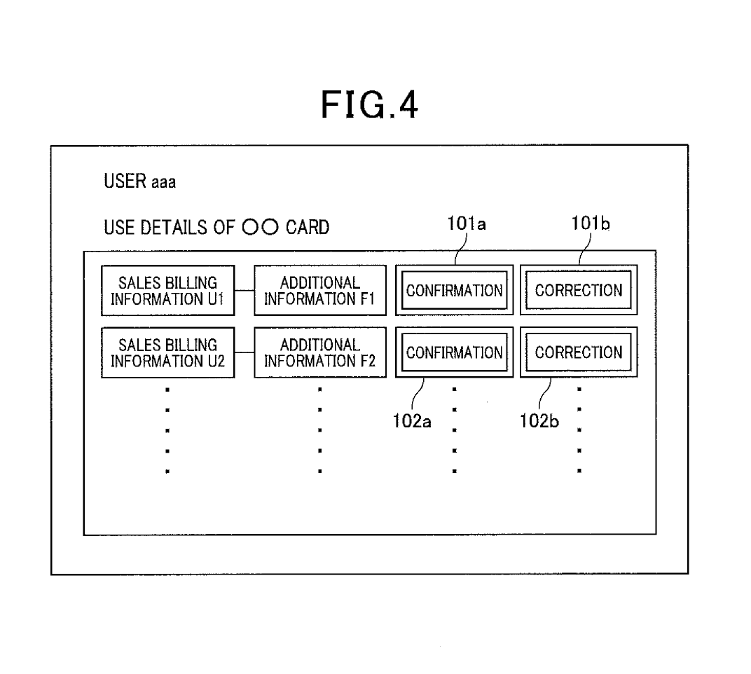

FIG. 4 is a diagram that illustrates a display example of sales billing information and additional information. In the example illustrated in FIG. 4, sales billing information U1 and additional information F1 are associated with each other, and a confirmation button 101a and a correction button 101b are displayed in association with each other for the association between the sales billing information U1 and the additional information F1. In addition, sales billing information U2 and additional information F2 are associated with each other, and a confirmation button 102a and a correction button 102b are displayed in association with each other for the association between the sales billing information U2 and the additional information F2. The user checks the association between the sales billing information U1 and the additional information F1 that are displayed and, in a case where the association is determined to be correct, makes an instruction for determining the association. The instruction for determining the association, for example, may be performed by clicking on the confirmation button 102a using a mouse or tapping the confirmation button 102a using a finger. In this way, the information registration unit 24c determines registration of the association between the sales billing information U1 and the additional information F1. On the other hand, the user checks the association between the sales billing information U1 and the additional information F1 that are displayed and, in a case where the association is determined not to be appropriate (in other words, in a case where the additional information is associated with the sales billing information that is not intended by the user to be associated with the additional information), makes an instruction for correcting the association. The instruction for correcting the association, for example, may be performed by associating the additional information F1 with intended sales billing information by clicking on the correction button 102b using a mouse or tapping the correction button 102b using a finger and performing drag-and-drop of the additional information F1. In this way, even in a case where the association between the additional information and the sales billing information is not appropriate, a correction can be made by the user such that the association between the additional information and the sales billing information is appropriate.

The association correction unit 24f receives a correction instruction for correcting the association between the additional information and the sales billing information from the user, for example, through the user terminal 5 and corrects the association between the additional information and the sales billing information registered by the information registration unit 24c based on the correction instruction. In this way, in the transaction information database 22c, the registration of the association between the sales billing information and the additional information is corrected.

### [2. Operation of Information Processing System S]

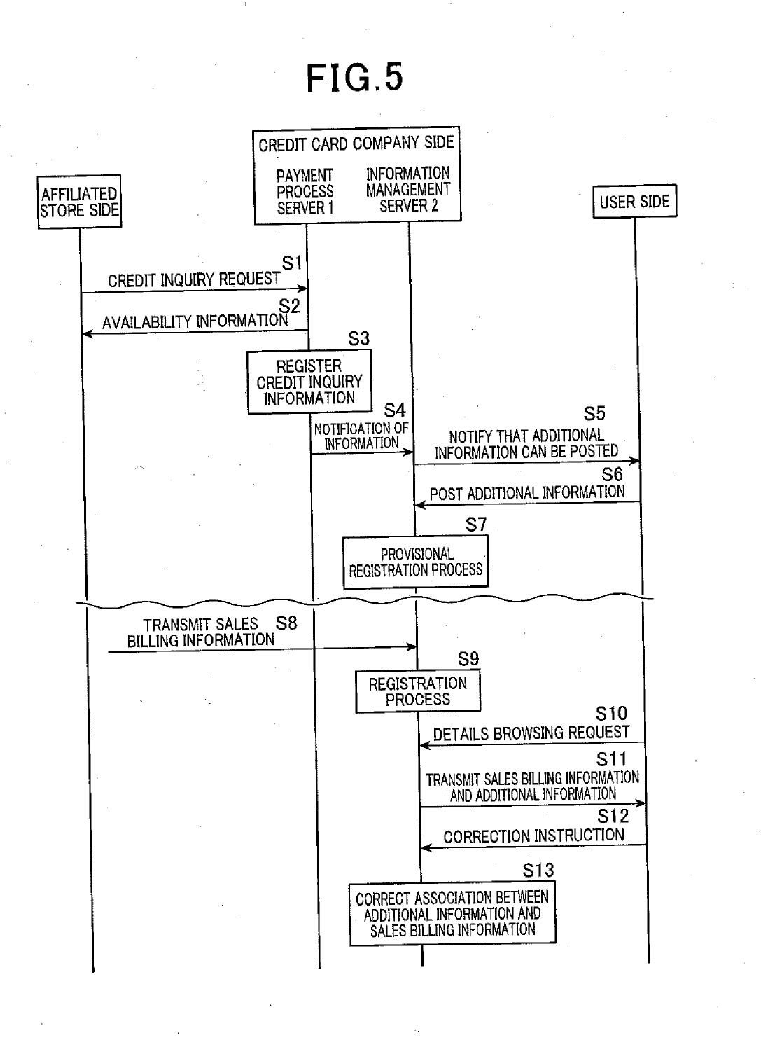

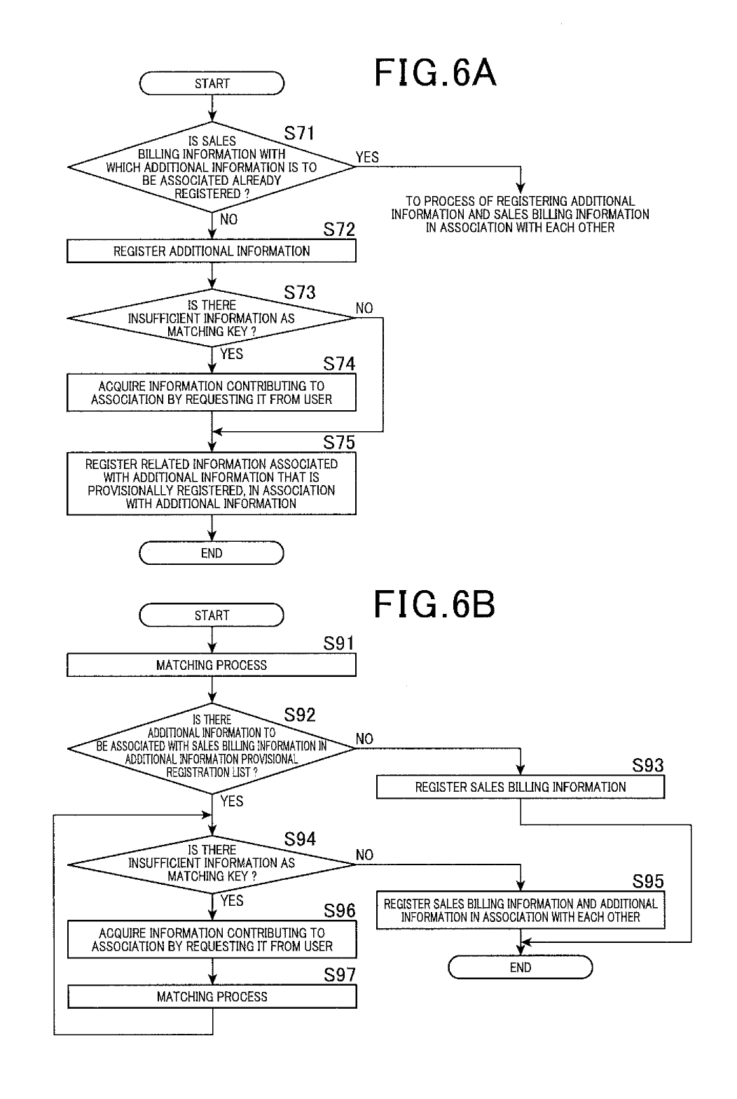

Next, the operation of the information processing system S according to this embodiment will be described with reference to FIGS. 5, 6A, and 6B. FIG. 5 is a sequence diagram that illustrates an example of the operation performed by the information processing system S. FIG. 6A is a flowchart that illustrates an example of the provisional registration process performed by the system control unit 24 of the information management server 2. FIG. 6B is a flowchart that illustrates an example of a registration process performed by the system control unit 24 of the information management server 2.

In the example represented in FIG. 5, in a case where a credit card is used by the user in a transaction with an affiliated store, the affiliated store, for example, transmits a credit inquiry request from the payment processing terminal 3 to the payment processing server 1 of the credit card company (step S1). The payment processing server 1 performs a process of the credit inquiry and the like in response to the credit inquiry request and, for example, replies to the payment processing terminal 3 with availability information that represents the availability/non-availability of the credit card (step S2). In addition, the payment processing server 1 acquires credit inquiry information representing a result of the credit inquiry and registers the acquired credit inquiry information in the credit inquiry history database 12 (step S3). The payment processing server 1 notifies the information management server 2 of information indicative of the presence of the credit inquiry (step S4). In this information, for example, a user name of the user who performs the transaction using the credit card and a card number of the credit card are included.

Then, the information management server 2 notifies the user who performs the transaction using the credit card that additional information for the transaction using the credit card can be posted (step S5). For example, the information management server 2 transmits an electronic mail to an electronic mail address specified based on the user name and the card number notified of from the payment processing server 1, thereby notifying the user that additional information can be posted. The user who performs the transaction using the credit card designates additional information to be posted in response to the notification indicating that the additional information can be posted (in step S6). For example, the user terminal 5 (for example, a mobile terminal) of the user receives an electronic mail transmitted from the information management server 2 through a mail server (not illustrated). Then, the user of the user terminal 5, for example, writes a comment to the received electronic mail, designates additional information by attaching image data of a picture (for example, a receipt) photographed at the time of the transaction according to a camera function of the user terminal 5, and replies using the electronic mail, thereby posting the additional information. For example, there are cases where position information (longitude and latitude information) acquired according to a GPS function of the user terminal 5 is added to the image data.

Alternatively, in step S5 described above, the information management server 2 may be configured to store a post request flag in association with a user ID specified based on the user name and the card number notified of from the payment processing server 1. In such a case, for example, after the user corresponding to the user ID logins a details browsing web site, the information management server 2 notifies the user terminal 5 that additional information can be posted on a web page to be transmitted to the user terminal 5. Then, in step S6 described above, the user using the user terminal 5 makes a reply with additional information being designated, for example, by writing a comment, for example, to an input form of the web page that is acquired from the information management server 2. In this way, the additional information is posted. In addition, in this case, the information management server 2, for example, may be configured to upload image data of a picture photographed at the time of the transaction according to the camera function of the user terminal 5 on the input form of the web page. The position information acquired according to the GPS function of the user terminal 5 may be added to the image data.

Then, when the additional information posted from the user is acquired, the information management server 2 starts the provisional registration process illustrated in FIG. 6A (step S7). In this provisional registration process, as illustrated in FIG. 6A, the system control unit 24 of the information management server 2 determines whether or not sales billing information with which the acquired additional information is to be associated is already registered (step S71). This determination, as described above, is made by matching up the additional information with the sales billing information registered in the transaction information database 22c by using the related information associated with the additional information as the matching key. Then, in a case where the sales billing information to which the acquired additional information is to be associated is determined to already be registered (Yes in step S71), the system control unit 24 causes the process to proceed to the process of registering the acquired additional information and the sales billing information in association with each other. On the other hand, in a case where the sales billing information to which the acquired additional information is to be associated is determined not to be registered (No in step S71), the system control unit 24 registers (in other words, provisionally registers) the acquired additional information in the additional information provisional registration list (step S72).

Next, the system control unit 24 determines whether or not there is insufficient information as the matching key (in step S73). For example, the system control unit 24, as described above, acquires credit inquiry information representing a credit inquiry of the user who posts the additional information from the payment processing server 1 and determines whether or not there is insufficient information as the matching key based on the acquisition state of the acquired credit inquiry information. Then, in a case where it is determined that there is no insufficient information as the matching key (No in step S73), the system control unit 24 causes the process to proceed to step S75. On the other hand, in a case where it is determined that there is insufficient information as the matching key (Yes in step S73), the system control unit 24 specifies information (for example, information according to the acquisition state of the credit inquiry information) that is sufficient as information contributing to the association, acquires the information by requesting the information from the user (step S74), and causes the process to proceed to step S75. In step S75, related information (including the acquired information contributing to the association in case of going through step S74) associated with the additional information that is provisionally registered is acquired, the acquired related information is registered in the additional information provisional registration list in association with the additional information, and the provisional registration process illustrated in FIG. 6A terminates. Through the process of step S75, for example, the electronic mail address of the electronic mail transmitting the additional information, the position information added to the image data, and the like and the acquired information contributing to the association are registered as related information, and the related information is used as the matching key. In addition, the system control unit 24 determines whether or not the insufficient information is necessary as the matching key at setting timing before the registration of the sales billing information from the acquisition of the additional information and, in a case where it is determined that the insufficient information is necessary, may be configured to request information contributing to the association from the user and add the information as the related information so as to be registered.

Meanwhile, in step S2 described above, the availability information representing the availability/non-availability of the credit card is replied, and, after a transaction is made between the user and the affiliated store, the affiliated store transmits the sales billing information of the transaction at timing determined by the affiliated store, for example, from the payment processing terminal 3 or the affiliated store terminal 6 to the information management server 2 (step S8). Then, when the sales billing information transmitted from the affiliated store is acquired, the information management server 2 starts the registration process illustrated in FIG. 6B (step S9). This registration process, for example, is started at timing at which the sales billing information is acquired, in other words, at the timing of sales billing. In this registration process, as illustrated in FIG. 6B, the system control unit 24 of the information management server 2 performs a matching process for matching up the additional information (in other words, the additional information registered in the additional information provisional registration list) that is provisionally registered with the acquired sales billing information (step S91). This matching process, as described above, is performed by the information registration unit 24c by using the related information associated with the additional information that is provisionally registered as the matching key.

Next, the system control unit 24 determines whether or not the additional information to be associated with the above-described sales billing information is present in the additional information provisional registration list through the matching process (step S92). Then, in a case where the additional information to be associated with the sales billing information is determined not to be present in the additional information provisional registration list (No in step S92), the system control unit 24 registers the acquired sales billing information in the transaction information database 22c without being associated with the additional information (step S93) and terminates the registration process illustrated in FIG. 6B.

On the other hand, in a case where the additional information to be associated with the sales billing information is determined to be present in the additional information provisional registration list (Yes in step S92), the system control unit 24 determines whether or not there is insufficient information as the matching key (Step S94). For example, in a case where there is a plurality of pieces of additional information to be associated with the sales billing information, and the additional information cannot be narrowed down to one piece of additional information, it is determined that there is insufficient information as the matching key. In addition, in a case where the additional information to be associated with the sales billing information is present in the additional information provisional registration list, the system control unit 24, as described above, may be configured to acquire credit inquiry information representing the credit inquiry of the user who posts the additional information from the payment processing server 1 and determine whether or not there is insufficient information as the matching key based on the acquisition state of the acquired credit inquiry information.

Then, in a case where it is determined that there is no insufficient information as the matching key (for example, the additional information is narrowed down to one piece of additional information) (No in step S94), the system control unit 24 specifies the acquired sales billing information and additional information to be associated therewith, registers the sales billing information and the additional information, which are specified, in the transaction information database 22c in association with each other (step S95), and terminates the registration process illustrated in FIG. 6B. In addition, in the additional information and the sales billing information that are registered in association with each other, a user ID of the user who posts the additional information is registered in association therewith. On the other hand, in a case where it is determined that there is insufficient information as the matching key (Yes in step S94), the system control unit 24, as described above, acquires information contributing to the association by requesting the information from the user (step S96). Next, the system control unit 24 performs a matching process for matching up the additional information determined to be present in the additional information provisional registration list in step S92 described above with the acquired sales billing information by using the information acquired in response to the request from the user as the matching key (step S97), and the process is returned to step S94 described above. When the process is returned to step S94, the system control unit 24 performs a process similar to that described above. In this case, for example, in a case where the additional information to be associated with the sales billing information cannot be narrowed down into one piece of additional information, the acquired sales billing information and the plurality of pieces of additional information determined to be present in the additional information provisional registration list may be configured to be registered in the transaction information database 22c in association with each other. In such a case, an instruction for correcting the association between the additional information and the sales billing information can be made by the user.

In addition, in step S92 described above, in a case where the additional information to be associated with the sales billing information is determined not to be present in the additional information provisional registration list, the sales billing information and the additional information to be associated with other cannot be specified, but, in such a case, the system control unit 24 may be configured to determine that there is insufficient information as the matching key. Then, the system control unit 24, as described above, acquires information contributing to the association by requesting the information from the user and performs a matching process for matching up the additional information that is provisionally registered with the acquired sales billing information again by using the information as the matching key. Then, in a case where sales billing information and additional information cannot be specified also by the matching process performed again, the system control unit 24 registers the acquired sales billing information without being associated with additional information.

Furthermore, the registration process illustrated in FIG. 6B may be configured to be performed not at the timing of sales billing but at predetermined timing (for example, every one day or every three days). In such a case, the system control unit 24, for example, selects sales billing information one piece at each time in order of acquisition based on the sales billing information that is acquired by the information acquisition unit 24a and is stored in a storage area used for storing the sales billing information and performs the registration process described above for each selected sales billing information.

Then, for example, after the user terminal 5 accesses and logins to the details browsing web site, a details browsing request is made (step S10). The system control unit 24 of the information management server 2 acquires the sales billing information and the additional information associated with the user ID of the login user from the transaction information database 22c in response to the details browsing request. Then, the system control unit 24 transmits a web page displaying the sales billing information and the additional information, which are acquired, with each other to the user terminal 5 (step S11). Accordingly, when the user makes a correction instruction for the association between the sales billing information and the additional information presented to the user using the user terminal 5 (step S12), the system control unit 24 receives the correction instruction from the user terminal 5 and corrects the association between the additional information and the sales billing information registered in the transaction information database 22c based on the correction instruction (step S13).

As described above, according to the above-described embodiment, the information management server 2 provisionally registers the additional information designated by the user as information relating to a specific event until the sales billing information relating to the specific event can be presented to the user. Then, after the sales billing information is acquired, since the sales billing information and the additional information, which is provisionally registered to be associated with the sales billing information, are configured to be registered to be presentable to the user in association with each other, the information management server 2 can easily associate (link) the above-described additional information and sales billing information that is not registered at the acquisition time point of the additional information.

In addition, in the above-described embodiment, in a case where the determination is made before the sales billing information with which the additional information is associated is acquired based on the related information associated with the additional information, the information management server 2 may be configured to present the additional information and the sales billing information to the user in association with each other before the acquisition of the sales billing information. For example, as illustrated in FIG. 3C, in a case where the sales billing information U1 of the transaction T1 is not acquired, but the additional information F1 is determined to be associated with the sales billing information U1 based on the related information associated with the additional information F1, even before the acquisition of the sales billing information U1, credit inquiry information Y1 of the transaction T1 and the additional information F1 are displayed on the display of the user terminal 5 in association with each other. Accordingly, also in a case where there is a plurality of candidates (for example, the sales billing information U1 and the sales billing information U2) with which the additional information F1 is associated, the user can easily determine one of the plurality of pieces of sales billing information with which the additional information F1 is associated. For this reason, the user can easily correct the association between the additional information and the sales billing information.

### [3. Information Processing System S According to Another Embodiment]

In the embodiment described above, while the embodiment of a case where the present invention is applied to the information processing system S that handles details of a transaction using a credit card has been described, the present invention may be applied to an information processing system that handles other details. For example, the present invention may be applied to a system that processes details of a transaction using a card (for example, a debit card) other than a credit card, details of a security transaction or a bond transaction, details of a transaction in an online auction, use details of an offline payment using electronic money, online deposit details for a bank, or details of a purchase made at an online shopping mall. Also in the case of such details, additional information designated by a user is provisionally registered until the details can be presented to the user, and, after the details are acquired, the details and the additional information that is provisionally registered are associated with each other and are registered to be presentable to the user.

In addition, other than the details described above, the present invention may be applied to an information processing system (for example, a document browsing system) that handles documents (amendments or opinion letters), for example, presented to a public organization or the like as the second information according to the present invention. In such a case, additional information designated by a user is provisionally registered until the document can be presented to the user, and, after the document is acquired, the document and the additional information that is provisionally registered are associated with each other and are registered to be presentable to the user. In the case, for example, a number assigned to an event (for example, an event relating to an application or a petition to a public organization) on which the above-described document is based or the like corresponds to the related information. In addition, the second information and the first information according to the present invention may not have a relation of master and servant unlike in the case of the details of a transaction and the additional information added to the details but may have a reverse relation thereof or an equivalent relation.

### REFERENCE SIGN LIST

1 Payment processing server
2 Information management server
21 Communication unit
22 Storage unit
23 Input/output interface unit
24 System control unit
24a Information acquisition unit
24b Additional information provisional registration unit
24c Information registration unit
24d Information requesting unit
24e Information presenting unit
24f Association correction unit
S Information processing system

1. An information processing apparatus comprising:
at least one memory operable to store program instructions;
at least one processor operable to access said program instructions and operate according to said program instructions, said program instructions including:
provisional registration instructions configured to cause at least one of said at least one processors to provisionally register first information designated by a user as information relating to a specific event until second information relating to the specific event becomes presentable to the user;
requesting instructions configured to cause at least one of said at least one processors to request sufficient information as information useful for association between the first information and the second information, from the user, in a case where there is insufficient information for the association, and compensate for information relating to the first information based on information acquired in response to the request; and
registration instructions configured to cause at least one of said at least one processors to, after the second information is acquired, associate the first information and the second information based on information relating to the first information, and register the first information and the second information associated with each other, to be presentable to the user.

2-3. (canceled)

4. The information processing apparatus according to claim 1,
wherein the registration instructions are further configured to cause at least one of said at least one processors to determine whether or not there is insufficient information for association before registration of the second information based on an acquisition state of information acquired before the second information.

5. The information processing apparatus according to claim 1,
wherein the requesting instructions are further configured to cause at least one of said at least one processors to request information that causes the user to select information greater or smaller than a predetermined thresthold, as the information useful for the association, from the user.

6. The information processing apparatus according to claim 1,
wherein the provisional registration instructions are further configured to cause at least one of said at least one processors to provisionally register the first information after an occurrence of the event.

7. The information processing apparatus according to claim 1,
wherein the second information is generated before the provisional registration of the first information.

8. The information processing apparatus according to claim 1,
wherein the registration instructions are further configured to cause at least one of said at least one processors to register the second information of which timing at which the second information becomes presentable is incapable of being controlled by the user.

9. The information processing apparatus according to claim 1,
wherein the first information is additional information designated by the user concerning a transaction between the user and a store,
the second information is sales billing information of a transaction that is provided from the store,
the registration instructions are further configured to cause at least one of said at least one processors to determine whether or not there is insufficient information for the association, before registration of the second information, based on an acquisition state of credit inquiry information that is acquired before the second information and represents a credit inquiry of the user, and
the requesting instructions are further configured to cause at least one of said at least one processors to request information useful for the association, from the user.

10. The information processing apparatus according to claim 1, further comprising:
first presenting instructions configured to cause at least one of said at least one processors to present the first information and the second information registered in association with each other to the user; and
correction instructions configured to cause at least one of said at least one processors to receive a correction instruction for association between the first information and the second information from the user, and correct the association between the first information and the second information registered based on the correction instruction.

11. The information processing apparatus according to claim 1, further comprising a-second presenting instructions configured to cause at least one of said at least one processors to present the first information and the second information in association with each other to the user before acquisition of the second information, in a case where the first information is determined to be associated with the second information based on information associated with the first information before the acquisition of the second information.

12. An information processing method executed by a computer,
the information processing method comprising:
provisionally registering first information designated by a user as information relating to a specific event until second information relating to the specific event becomes presentable to the user;
requesting sufficient information as information useful for association between the first information and the second information, from the user, in a case where there is insufficient information for the association, and compensating for information relating to the first information based on information acquired in response to the request; and
after the second information is acquired, associating the first information and the second information based on information relating to the first information, and registering the first information and the second information associated with each other, to be presentable to the user.

13. A non-transitory recording medium recording an information processing program that causes a computer to:
provisionally register first information designated by a user as information relating to a specific event until second information relating to the specific event becomes presentable to the user;
request sufficient information as information useful for association between the first information and the second information, from the user, in a case where there is insufficient information for the association, and compensate for information relating to the first information based on information acquired in response to the request; and
after the second information is acquired, associate the first information and the second information based on information relating to the first information, and register the first information and the second information associated with each other, to be presentable to the user.
